(19) United States
(12) Patent Application Publication
(10) Pub. No.: US 2013/0346126 A1
(43) Pub. Date: Dec. 26, 2013

(54) BUSINESS PROCESS DEVELOPMENT

(71) Applicants: JOHANN KEMMER, Muehlhausen (DE); Martina Rothley, Schwetzingen (DE)

(72) Inventors: JOHANN KEMMER, Muehlhausen (DE); Martina Rothley, Schwetzingen (DE)

(21) Appl. No.: 13/532,803

(22) Filed: Jun. 26, 2012

(51) Int. Cl. G06Q 10/00

(52) U.S. Cl. 705/7.11

(57) ABSTRACT

Various embodiments of systems and methods for composing business processes using customized business process elements are described herein. The method involves creating one or more partner-defined business process elements composed of a source business object node and a target business object node. Further, the method includes selecting a type of communication interface between the source business object node and the target business object node based on determining a relative location of the source business object node and the target business object node. In another aspect, the composed one or more business process elements are integrated to form a customized business process. In yet another aspect, the method includes switching business entities to the composed business process based on the partner-defined business process elements and persisting the developed business process in the repository.

### FIELD

The field relates to business software applications. More precisely, the field relates to composing business processes using customized business process elements.

### BACKGROUND

Software implementation partners often need to modify business processes, provided in standard business software applications, in order to accommodate customer or industry specific requirements. The modification should be applied consistently across the whole technology stack, including all involved business entities such as user interfaces, forms, reports, tasks, etc. in an easy to use manner. Currently, adaptations to business processes are restricted to shortening and extension of standard business processes; replacement of parts of the standard business process by other standard process elements; and replacement of complete standard process by self-defined business processes consisting of standard business process elements.

Moreover, with the current business process adaptation techniques, flexible definition of business processes is challenging or simply not possible for customers and software implementation partners relying on standard business application products. The standard business processes offered by those products are in general inflexible and rigid and do not provide any ability to modify or enhance business process chains.

Even in rare cases, where business process definition in a standard product is allowed, such functionality is either restricted to very special use cases such as process-oriented field extensibility or the functionality is not able to provide the relation between business process elements and business entities.

Furthermore, there is no means for software partners to define and integrate customized business process elements into standard business processes or to build new business processes that are composed solely or partly by partner-defined business process elements, while hiding the complexity by automating the transport of the integration to all related business entities. The automation in transporting the integration to all related business entities is to ensure consistent behavior of the entire software solution.

As a consequence, software partners have to adapt their real-time business to the software standards often leading to additional, unnecessary costs and lowering efficiency and productivity. On the other hand, software partners are forced to implement the required processes from scratch on their own in separate, stand-alone software products instead of adapting standard ERP software and making use of its rich portfolio of predefined business processes.

### SUMMARY

Various embodiments of systems and methods for composing business processes using partner-defined business process elements are described herein. In an embodiment, the method includes creating one or more partner-defined business process elements composed of a source business object node and a target business object node. The source business object node and a target business object node are selected from a business process repository holding partner-defined process entities. Examples of process entities include business object nodes, process agents, and the like. Further, the method includes the automatic selection of the appropriate type of communication interfaces between the source business object node and the target business object node based on determining a relative location of the source business object node and the target business object node, e.g. with respect to foreseen deployment units or deployment systems. In another aspect, the composed one or more business process elements are integrated to form a customized business process. In yet another aspect, the method includes switching business entities to the composed business process based on the partner-defined business process elements and persisting the developed business process in the repository.

In other embodiments, the system includes a processor for executing program code and memory in communication with the processor. The system also includes a data source system such as a business process repository that holds partner-defined process element entities. The processor executes the program code to compose one or more partner-defined business process elements. In an aspect, the one or more partner-defined business process elements are composed by the processor, by selecting a source business object node and a target business object node from the data source system, wherein the data source system holds partner-defined business entities. Further, the processor executes the program code to determine a relative location of the source business object node and the target business object node and automatically select a communication interface between the source business object node and the target business object node based on the relative location. The processor further executes the program code to switch business entities to the composed business process based on the partner-defined business process elements and persisting the composed business process in the repository.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram representing a system of business process adaptation, according to one embodiment.

FIG. 2 is a flow diagram of an embodiment of a method of composing business processes using customized business process elements.

FIG. 2A is a flow diagram of an embodiment of a method of composing a partner-defined business process element.

FIGS. 3-8 are a block diagram representations of various compositions of a business process using partner-defined business process elements.

FIG. 9 is a block diagram of an embodiment of a system of business process development.

FIG. 10 is an exemplary screenshot depicting a tool for building business processes, according to an embodiment.

FIG. 11 is an exemplary screenshot depicting the business process development approach using the tool, according to an embodiment.

FIG. 12 is a block diagram illustrating a computing environment in which the techniques described for business process adaptation can be implemented, according to an embodiment.

### DETAILED DESCRIPTION

Embodiments of techniques for composing business processes using customized business process elements are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

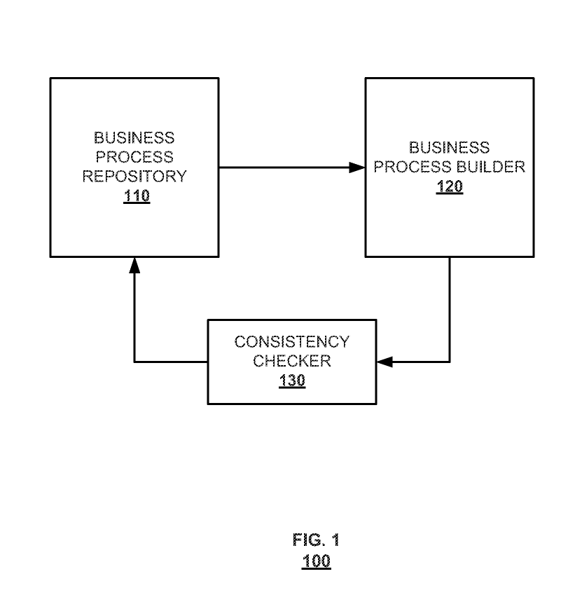

FIG. 1 is a block diagram representing a system 100 of business process development, according to one embodiment. The system 100 includes a business process repository 110 and a business process builder 120 used by software implementation partners for business process definition. A business process repository 110 includes standard business processes and business process elements as well as customized business processes and business process elements. Standard business processes are business processes that are predefined by the business software vendor and stored in the business process repository 110. On the other hand, customized business processes and business process elements are defined by a software implementation partner. Business process elements typically are the most granular pieces of a business process in terms of business process composition. Business processes include one or more business process elements.

Business objects (BOs) are real world objects. For example, an employee or a sales order may be modeled as business objects in business application systems. Business objects are composed of business object nodes representing individual aspects of the business object. In one embodiment, business process elements are composed by two business object nodes. Two business object nodes representing a business process element may also represent the data flow between them. The data flow starts with the source (typically left side) of the business process element and ends at the target (typically right side) of the business process element. This holds true in case both business objects belong to the same deployment unit. Otherwise, business process elements consist of two business object nodes and their process agents. Process agents are pieces of software connecting two business objects which reside on different deployment units, which themselves could be deployed on different systems or tenants. For example, in case a business process element crosses deployment unit boundaries, a direct communication between business objects is not suitable as each deployment unit may reside in different applications or enterprise requiring a message-based communication. Therefore, the partner business process definition also contains the information about involved process agents, which represent the outbound and inbound application-to-application (A2A) messages. Examples of business process elements are:

Sales Quote Item->Sales Order Item; and

Sales Order Header->Service Confirmation Header.

As stated above, the left side of the business process elements is typically the source and the right side is typically the target, which also depicts the data flow between the nodes building a business process element.

In an embodiment, the business process builder 120 is operable to transform a standard business process into a customized business processes by integrating partner-defined business process elements into the standard business process. In an aspect, the standard business process refers to a business process that is pre-defined and pre-delivered by a business software vendor, in which, the business process elements forming the standard business process are pre-defined and arranged in a pre-defined order by the business software vendor. In another embodiment, the business process builder 120 is operable to develop a new business process that is composed wholly or partly of partner-defined business process elements. The phrase “partner-defined business process elements” as used herein refers to business process elements that are created by a software implementation partner or a key user at the customer side. The business process builder 120 is provided with partner-defined business process elements along with pre-defined (standard) business process elements by the business process repository 110. After transforming an existing business process or creating a new business process by the business process builder 120, a consistency checker 130 is responsible to connect or disconnect business entities to the partner-defined business process elements to guarantee consistent business process composition. Examples of business entities relevant to business processes for a standard business software application are: business objects and business object nodes; user interfaces, such as work centers; work center views, floor plans to create, update, delete and display of business objects, queries, etc; print forms, interactive forms; analytical reports; and tasks. To connect or disconnect the business entities to the respective business process elements, the consistency checker 130 should be aware of the relation between the business entities and the business process elements. In some embodiments, the mechanism to connect or disconnect business entities to business process elements may also be referred to as Business Entity Process Switches. Business entities are assigned to one edge (source or target) of a business element, thus a business object node. The system automatically resolves the relationship between the business entity, the business object node as part of a business process element and the business process element itself.

Business entities of a business software solution are assigned to one or more business process elements. Standard software delivery includes the assignment of all relevant business entities to business process elements. Multiple assignments of one business entity to several business process elements may be possible, because most standard business entities participate in more than one business process. Examples of assignment of business entities to standard business process elements are:

Business Entity Work Center View “Sales Order” [symbol] Business Process Element “Sales Order to Service Order”, BO node “Sales Order Header”;
Business Entity: Report “invoicing Volume” [symbol] Business Process Element “Customer Invoicing to Supplier Invoicing”, BO node “Customer Invoicing Header”; and
Business Entity: Form “Service Order Confirmation” [symbol] Business Process Element “Service Order to Service Order Confirmation”, BO node “Service Confirmation Header.”

The assignment of standard business entities to newly created partner-defined business process elements, by a customer or software implementation partner, should be possible to ensure consistency of the developed business processes and to guarantee execution of business (in terms of user interfaces etc.) along the modified or new business process. Standard business software solution delivery contains switches for standard business entities and standard business process elements that are stored in a Business Process Switch Framework (BPSF). In addition to the standard business process switches, the BPSF stores information regarding the relationship between new self-defined or imported business process elements and partner-defined business process elements, for evaluation during runtime. The business configuration decides the activation status of each switch. If business process elements are de-selected in scoping, the corresponding business entity switches are switched off. After the activation of a business process composition or definition (see Table 1) the corresponding process switches are evaluated and will be activated or de-activated,

TABLE 1

| | Business Process | | Process |
|---|---|---|---|
| Business Entity | Element | BO Node | Switch |
| Work Center View | Quote to Service | Service Order | off |
| “Service Orders” | Order | Header | |
| Work Center View | Service Order to | Service Order | on |
| “Service Orders” | Service Confirmation | Header | |
| Report | Opportunity to Sales | Sales Order | off |
| “Sales Volume” | Order | Header | |
| Report | Service Order to | Service Order | off |
| “Sales Volume” | Invoice Request | Header | |
| Work Center View | Partner-defined | Partner-defined | on |
| “Partner | Business Process | Business Object | |
| Application” | Element A | X | |
| Partner report | Partner-defined | Partner-defined | on |
| | Business Process | Business Object | |
| | Element B | Y | |

As a consequence, business entities will be switched on or off depending on their active process switches. During runtime, a business entity is switched off only if all its business process switches are off; on the other hand, a business entity is switched on, if at least one of its business process switches is on. In the example given in Table 1, the report “Sales Volume” should be switched off completely during runtime.

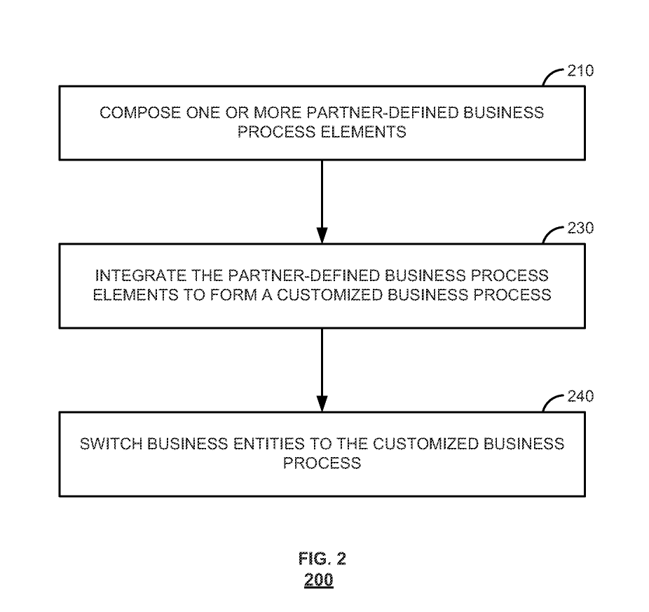

FIG. 2 is a flow diagram of an embodiment of a method 200 of business process adaptation. The method begins at block 210 with composing one or more partner-defined business process elements. The business process elements are the most granular elements required for the business process composition. In one embodiment, the business process elements are composed by two business object nodes representing also the data flow between the two business objects.

The method of composing a partner-defined business process element is described with reference to FIG. 2A. The method begins at block 212 with selecting a source business object node and a target business object node from a business process repository. In an aspect, either of or both the source and target business object node is a partner-defined BO node. The business process repository holds standard business processes, standard business process elements, and standard business objects. The business process repository also holds business objects defined by the partner. The term “partner” as used herein may refer to a key user of the business software at the customer side or a software implementation partner. The term “key user” as used herein refers to a person or entity designing/customizing the software application. In an aspect, the partner-defined business objects are created by the partner using a wizard-based approach, in which, the business objects are populated by elements like fields, associations and actions using a declarative method. In an aspect, based on the business object definition, communication interfaces and process agents can be generated automatically and the partner-defined business objects and process agents are stored in the business process repository.

At block 215, a relative location of the selected source business object node and the target business object node is determined. Herein, a location of the business object node refers to the deployment unit associated with the business object node. The deployment unit consists of a build (an executable collection of components), documents (end-user support material and release notes) and installation artifacts. In an aspect, for example, all BOs including its nodes are part of exactly one deployment unit. In an aspect, based on the relative location of the source and target business object node, a process agent or communication interface is selected as communication pattern for data exchange between the two business object nodes. Process agents are pieces of software connecting two business objects, which may be deployed on different deployment units, which in-turn could be deployed on different enterprise systems or tenants. In an aspect, the appropriate process agents may be automatically selected and attached by a business process element builder based on determining the location of the source and target business object nodes.

At block 217, it is determined whether both the source and target business object nodes are associated with the same deployment unit. If both the source and target business object nodes are associated with the same deployment unit, then a direct communication between the two business object nodes is selected at block 220. Otherwise, at process block 222, it is determined whether the source and target business object nodes are deployed in two different deployment units within the same enterprise. In case the source and target business object nodes are deployed across two different deployment units i.e., if a business process element crosses deployment unit boundaries, a direct communication between business objects is not suitable as both deployment units may reside in different systems requiring a message-based communication. Therefore, a process agent for the outbound (source BO node) and inbound (target BO node) messages such as an application-to-application (A2A) communication pattern is selected at block 225. The A2A communication pattern provides for data exchange between two applications in one business process platform within the same enterprise; connect complex applications and data sources within a company to integrate processes using standards-based XML and Web Services messaging in order to forward information and automate business processes.

Otherwise, at block 226, it is determined that the source and target business object nodes are deployed in two different deployment units and therefore potentially across different enterprises. Subsequently, a business-to-business (B2B) communication pattern or an application-to-X user (A2X) communication pattern is selected at blocks 227 and 228 respectively. A B2B communication pattern provides for data exchange between two business process platforms across enterprise boundaries; connect complex applications and data sources across companies to integrate processes using standards-based XML and Web Services messaging in order to forward information and automate business processes. Whereas, A2X communication pattern could be configured for extensions of the standard software. The partner-defined business process elements composed as shown in blocks 212 to 228 are then stored in the business process repository.

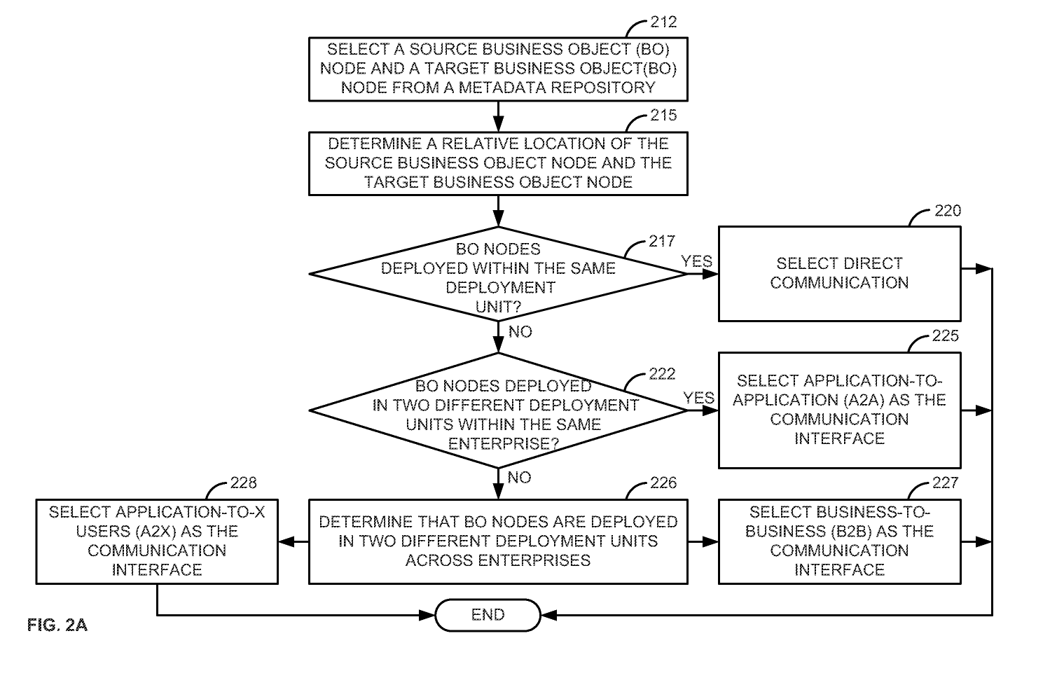

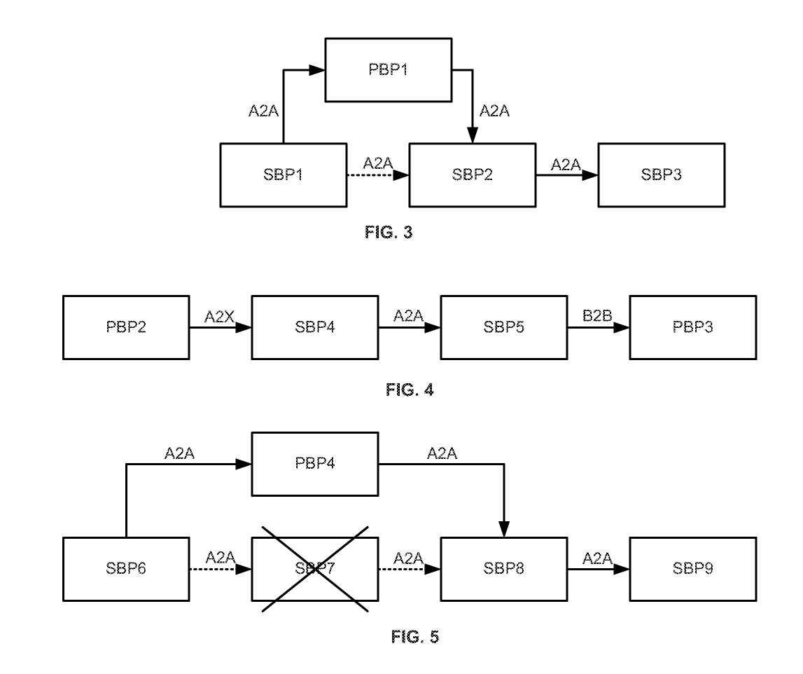

Referring back to FIG. 2, at block 230, the partner-defined business process elements are integrated to form a business process that is customized according to the specific requirements of the partner. In one embodiment, the customized business process is developed by integrating the partner-defined business process elements into a standard business process. In an example, the customized business process is developed by embedding the partner-defined business process elements with the standard business process chain. In another example, the customized business process is developed by linking the partner-defined business process elements to the pre-defined business process elements of the standard business process. In yet another example, the customized business process is developed by substituting partner-defined business process elements for pre-defined business process elements in the standard business process. In another embodiment, the customized business process is formed exclusively of partner-defined business process elements, in which, the partner-defined business process elements are combined in a partner-defined order. The various compositions of a business process using partner-defined business process elements will be explained with reference to illustrations shown in FIGS. 3-7.

At block 240, business entities are switched to the developed business process based on the reused identified pre-defined business process elements or the partner-defined customized business process elements. This step ensures consistency for the newly developed business process. In one embodiment, the relationship between the business process elements (both reused pre-defined and customized) and the business entities are determined. In some embodiments, business entities relevant to business processes for a standard business software application as well as a customized standard business software application may be: business objects and business object nodes; user interfaces, such as work centers, work center views, floor-plans for create, update, delete and display of business objects, queries, etc.; print forms, interactive forms; analytical reports; and tasks.

In an aspect, the developed business process is persisted in a repository. The repository includes business processes and business process elements that may be reused for further business process adaptation.

In an example, as shown in FIG. 3, a partner defined business process element PBP1 is embedded in a standard business process chain having pre-defined business process elements SBP1, SBP2, and SBP3. In another example, as shown in FIG. 4, partner-defined business process elements PBP2 and PBP3 can be linked to standard business processes across different partner applications (consisting of one or more business processes) via A2X or B2B communication interfaces. Alternatively, as shown in FIG. 5, a partner-defined business process element PBP4 can be substituted in place of a standard business process element SBP7 of a standard business process chain having other standard business process elements SBP6, SBP8, and SBP9. One ordinarily skilled in the art would understand that the process agents A2A, A2X, and B2B as used in the FIGS. 3-7 are for illustrative purposes only and other communication patterns are envisaged and are well within the scope of the embodiments.

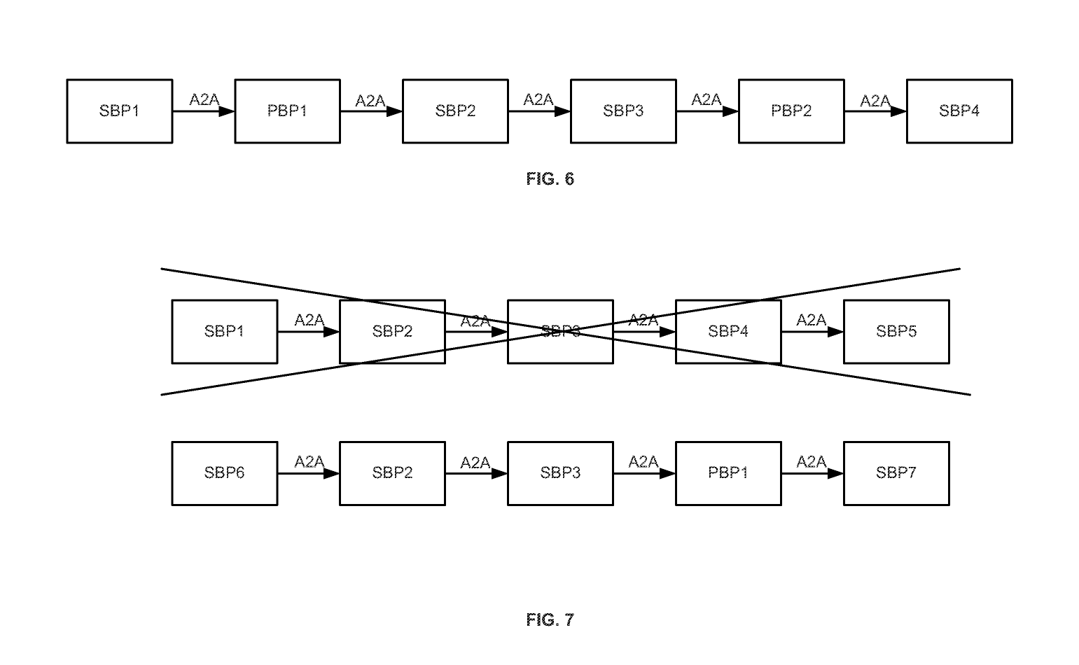

In another embodiment a new business process chain can be composed by the partner using a combination of partner-defined business process elements and standard business process elements and arranged in a partner-defined order. In an example, as shown with reference to FIG. 6, partner-defined business process elements PBP1 and PBP2 and pre-defined standard business process elements SBP1, SBP2, SBP3, and SBP4 are combined to form a new business process chain. In an aspect, the partner-defined business process elements can be defined in the same solution associated with the partner or imported from another solution not associated with the partner. Also, the pre-defined standard business process elements and the partner-defined business process elements can be retrieved from the business process repository where it is stored. In another embodiment, as shown in FIG. 7, the pre-defined standard business process elements and the partner-defined business process elements are composed into a partner-defined business process chain and the composed partner-defined business process chain is used to replace a pre-defined standard business process.

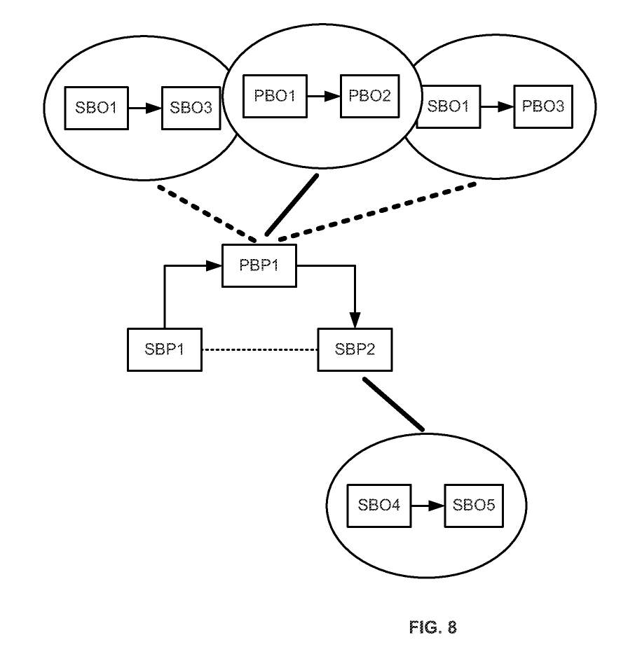

FIG. 8 illustrates an abstract view of a business process composition showing various combinations of business process objects within a partner-defined business process element. In the given example, a partner-defined business process element PBP1 is embedded with a pre-defined standard business process formed of standard business process elements SBP1 and SBP2. The standard business process elements are composed of standard business process objects. For example, the standard business process element SBP2 is composed of standard business objects SBO4 and SBO5. On the other hand, the partner-defined business process element PBP1 is composed of either wholly or partly of partner-defined business objects or composed of standard business process objects however according to partner-defined arrangement. For example, as shown, the partner-defined business process element PBP1 may be composed exclusively of partner-defined business objects PBO1 and PBO2. Alternatively, the partner-defined business process element PBP1 may be composed of a partner-defined business object PBO3 and a standard business object SBO1. Otherwise, the partner-defined business process element PBP1 may be composed of standard business objects SBO1 and SBO3 that are either arranged according to a partner-defined order or connected by partner-defined process agent, or both.

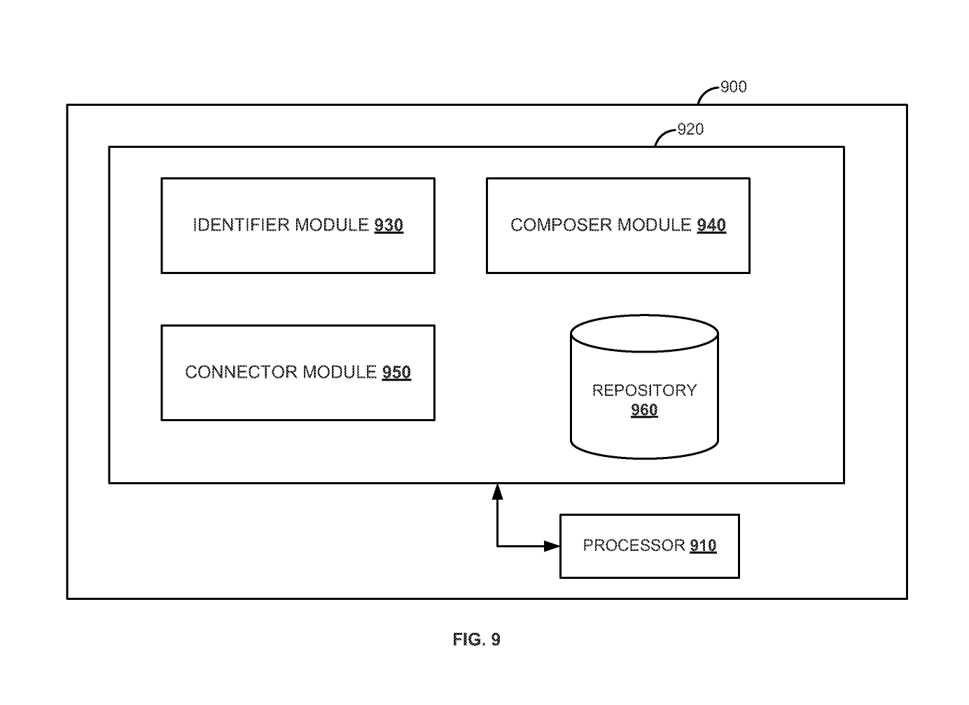

FIG. 9 is a block diagram of an embodiment of a system 900 for business process development. The system 900 includes a processor 910 for executing program code and computer memory 920 in communication with the processor 910. The memory 920 further includes an identifier module 930 to identify partner-defined business process elements from pre-defined and customized business process elements stored in a repository 960. In one embodiment, the business process elements are granular pieces for the business process composition. In one embodiment, the business process elements are composed by two business object nodes representing also the data flow between tire two business objects.

A composer module 940 is operable to use the identified partner-defined business process elements and pre-defined business process elements by the identifier module 930 to compose a customized (partner-defined) business process. In one embodiment, the composer module 940 is further operable to transform a pre-defined standard business process into a customized business process using the identified partner-defined business process elements and pre-defined business process elements. In another embodiment, the composer module 940 is further operable to add identified partner-defined business process elements to the pre-defined standard business process and remove identified pre-defined business process elements from tire predefined business process.

A connector module 950 is operable to switch business entities to the customized business process that is developed partly or wholly using partner-defined business process elements. The connector module 950 ensures consistency for the newly developed business process. In one embodiment, the connector module 950 is operable to determine the relationship between the partner-defined business process elements and the business entities,

The repository module 960 is used to persist the developed business processes and partner-defined business process elements that may be reused for further business process transformation or creation. The repository also holds the relation between the business process elements and the business entities.

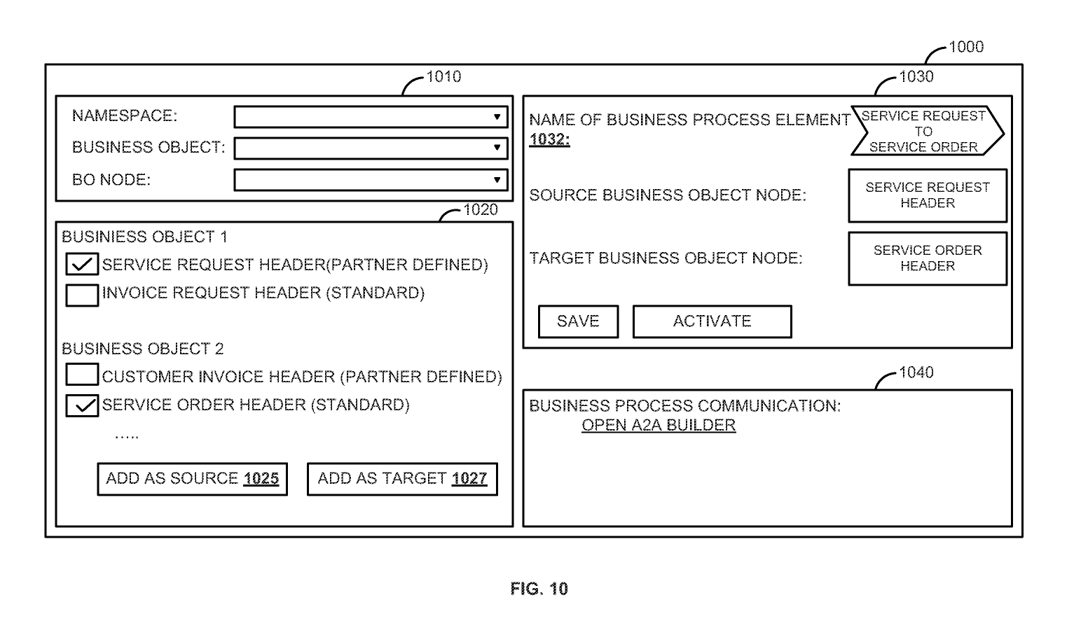

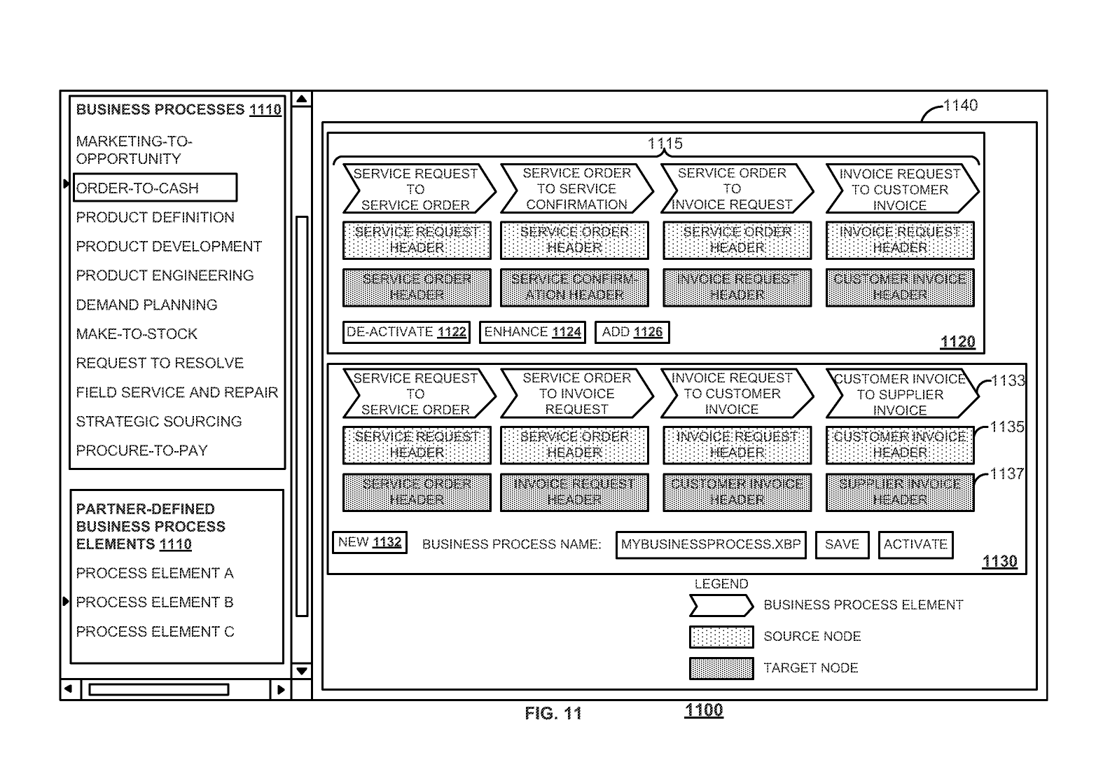

A tool for the customization of standard business processes and the composition of new partner-defined business processes may be embedded into a key user tool designed for customers or a partner development workbench supporting the whole process of partner add-on development. As an example, the business process adaptation and composition for software implementation partners is depicted in FIG. 10 and FIG. 11. A tool for customer process definition could be realized in a similar way.

Partners using a development workbench could start a business process customization and composition process by invoking a predefined template for creating partner-defined business process elements as depicted in FIG. 10. After invoking the template for creating partner-defined business process elements, a tool for the selection of standard business processes and the editing of the standard business processes will be invoked. An exemplary tool for the selection of standard business processes and the editing of the standard business processes is depicted in FIG. 11.

Referring to FIG. 10, the business process element creation tool 1000 includes one or more fields for specifying keywords or parameters for searching business object nodes from a business process repository. In the given example, search fields 1010 Namespace, Business object, BO node can be populated using search terms in order to produce more relevant search results. The search results are listed in a search results field 1020. In the given example, the search results include one or more partner-defined business object nodes as well as pre-defined standard business object nodes. Further, the search results field 1020 includes user-selectable options “Add as Source” 1025 and “Add as Target” 1027 for selecting one of the business object nodes in the search result as a source BO node and one of the business object nodes in the search results as a target BO node. The selected source BO node and the target BO node may be automatically populated in a composition field 1030, in an aspect, the source and target BO nodes can be selected by simply dragging and dropping the BO nodes from the results field into a composition field 1030. In the composition field 1030, a partner may provide a name for the business process element being created, in the field 1032, and save or activate the created business process element in the repository. In an embodiment, in response to receiving a selection for the source BO node and the target BO node, the tool 1000 automatically identifies an appropriate communication interface and provides the identified communication interface in a business process communication field 1040. Further, in an aspect, the tool 1000 automatically attaches the identified process agent to the created business process element.

FIG. 11 illustrates the tool 1100 for transforming a standard business process into a customized business process or creating a new partner-defined business process. As shown, the tool 1100 includes a business process selection area 1110 providing a user-selectable list of standard and customized business processes, and a user-selectable list of partner-defined business process elements. In an aspect, the list of partner-defined business process elements is imported from the business process repository. The standard business processes provided in the selection area 1110 can be selected for transforming it into a customized business process or to be used as a template for a new partner-defined business process. A business process editor 1140 renders a business process according to the selection made in the business process selection area 1110. The process elements are shown as Chevron graphs 1115. The business process editor 1140 includes a business process customization area 1120 and business process composition area 1130. The tool serves two purposes: customization of standard business processes and composition of new business processes. The new business processes may be individually delivered into a customer system or added as a business software application add-on. The business process customization area 1320 is where the selected standard business process is displayed with its business process elements, including the functions for deactivation 1122 and enhancement 1124. The business process composition area 1130 is where the business processes may be composed process element-by-process element or enhanced by standard business process elements picked from the standard business process rendered in the business process customization area 1120. In the tool, the business process elements are displayed by their names (e.g. 1133). Additionally, the source and the target business object nodes are specified (e.g. 1135 and 1137 respectively) below the respective business process elements. The tool may also be re-used as a business process editor in order to allow changes to the customized or newly defined business processes later on.

For business process customization, the user selects one of the pre-defined standard business processes from the selection area 1110 of the tool (e.g. Order-to-Cash). Automatically, the business process elements that the selected standard business process is composed of are displayed in the business process editor window 1140 of the tool, e.g. as Chevron graphs (e.g. Order-to-Cash: Service Request to Service Order, Service Order to Service Confirmation, Service Order to Invoice Request, Invoice request to Customer Invoice). The user can choose between the functions “De-activate” 1122 for deactivating a single business process element and “Enhance” 1124 for enhancing a standard business process by partner-defined business process elements or business process elements of other standard business processes.

To shorten a standard business process (either at beginning, middle or end), the user can mark one of the process elements (e.g. Order-to-Cash: Service Order to Service Confirmation) and selects the “De-activate” option. As a consequence, the chosen business process element is de-activated so the business process runs without this process element. After de-activation, the process element in question is displayed differently in the business process Chevron graph (e.g. in different colors, grayed out). Also the related business entities (e.g. Order-to-Cash: Interactive Service order Form) are de-activated via corresponding business process switches. In order to guarantee that the business process is still running without gaps, the standard business process has to be enhanced by further elements like additional process agents in case the de-activated process element bridged deployment unit (DU) boundaries, and the related business entities have to be switched accordingly via the mechanism described before. This can also include the replacements of user interfaces (UIs) in case the original entry point has been skipped by the de-activation.

To add farther business process elements such as a partner-defined business process element to a standard business process, the user selects a standard business process from the selection area 1110 and activates the “Enhance” 1124 option. As a consequence, the selected standard business process is copied to the business process composition area 1130. Next, the user chooses one of the partner-defined business process elements (e.g., Customer Invoice to Supplier Invoice), from the selection area 1110 of the tool. Finally, in order to add the selected partner-defined business process element to the standard business process in the composition area 1130, the user drags the partner-defined business process element to be added from the selection area 1110 and drops it between two active business process elements of the standard business process in the composition area 1130. Alternatively, the “Add” 1126 functionality could be used for the same purpose. Additional process element entities (as process agents) are added automatically. Also, related business entities are switched accordingly.

Replacement of business process elements by other standard business process elements can be realized by combining both actions “De-activate” 1122 and “Enhance” 1126. In both cases, the customized standard business process has to be stored in a metadata repository for further editing and access during runtime. Therefore, the business process has to be given a name. Implicitly, also a unique identification is generated by the system in the background and the connection to the original standard business process is stored. After its activation the business process adaptation will be effective in the system. During runtime, the system overlays the standard business processes by customizations related to them.

In the same tool, a new business process could be composed (e.g. Processing Purchase Orders: Create/Maintain Purchase Order, Send Purchase Order, Approve Purchase Order, Monitor Purchase Order=>standard process shortened and changed). In order to do so, the user selects the “New” 1132 option in the composition area 1130 of the business process editor 1140. As a consequence, an empty business process skeleton will be displayed in the composition area 1130 to be filled in the next steps. Business process(es) and business process elements composing the new business process are picked up from the corresponding sub-areas of the selection area 1110. Optionally, one or more standard business processes elements can also be picked from other standard business processes provided in the selection area 1110. In order to select a standard business process element, the user selects a standard business process in the business process selection area 1110 of the tool. Automatically the business process in its elements will be shown in the adaptation area 1120 of the business process editor 1140. Then, the selected partner-defined business process elements are added by dragging process elements from the selection area 1110 and the selected standard business process elements are added by dragging the standard business process elements from the adaptation area 1120 and dropping them at the desired position in the process composition area 1130, thus composing the new business process. Alternatively, the “Add” 1126 button could be used in the composition. If applicable, consistency checks are automatically performed by the system to facilitate the composition of a new partner-defined business process. When saving and activating the new business process, the system sets switches and generates process agents and switches in order to guarantee process consistency during runtime.

Some of the above described embodiments resolve the restriction of partner-defined business processes to be composed only by pre-defined business process elements, by giving them the ability to integrate customized business process elements. The embodiments described herein gives software implementation partners enhanced flexibility in terms of replacing pre-defined business process elements by partner-defined business process elements, extending pre-defined business processes by partner-defined business process elements, and composing new business processes by partner-defined business process elements.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media: and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

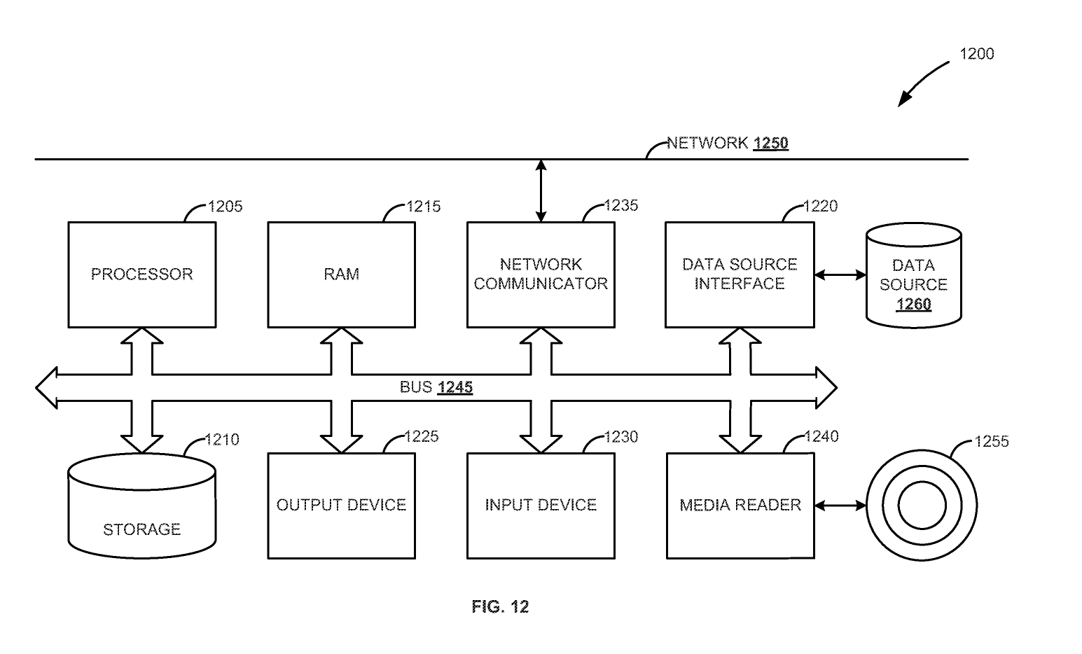

FIG. 12 is a block diagram of an exemplary computer system 1200. The computer system 1200 includes a processor 1205 that executes software instructions or code stored on a computer readable storage medium 1255 to perform the above-illustrated methods. The computer system 1200 includes a media reader 1240 to read the instructions from the computer readable storage medium 1255 and store the instructions in storage 1210 or in random access memory (RAM) 1215. The storage 1210 provides a large space for keeping static data where at least some instructions could be stored for later execution. The stored instructions may be further compiled to generate other representations of the instructions and dynamically stored in the RAM 1215. The processor 1205 reads instructions from the RAM 1215 and performs actions as instructed. According to one embodiment, the computer system 1200 further includes an output device 1225 (e.g., a display) to provide at least some of the results of the execution as output including, but not limited to, visual information to users and an input device 1230 to provide a user or another device with means for entering data and/or otherwise interact with the computer system 1200. Each of these output devices 1225 and input devices 1230 could be joined by one or more additional peripherals to further expand the capabilities of the computer system 1200. A network communicator 1235 may be provided to connect the computer system 1200 to a network 1250 and in turn to other devices connected to the network 1250 including other clients, servers, data stores, and interfaces, for instance. The modules of the computer system 1200 are interconnected via a bus 1245. Computer system 1200 includes a data source interface 1220 to access data source 1260. The data source 1260 can be accessed via one or more abstraction layers implemented in hardware or software. For example, the data source 1260 may be accessed by network 1250. In some embodiments the data source 1260 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method for composing a business process using partner-defined business process elements, the method comprising:
composing one or more partner-defined business process elements comprising:
selecting a source business object node and a target business object node from a business process repository, wherein the business process repository holds partner-defined process entities;
determining a relative location of the source business object node and the target business object node; and
selecting a communication interface for the source business object node and the target business object node based on the relative location of the source business object node and the target business object node;
integrating the partner-defined business process elements to form a customized business process; and
switching business entities to the customized business process.

2. The method of claim 1, wherein the partner-defined business process elements are composed of two business object nodes, the two business object nodes representing data flow between the two business objects.

3. The method of claim 1, wherein switching the business entities to the customized business process comprises switching at least one of user interfaces, forms, reports, tasks, and any other business process/element dependent entities to the customized business process using information on a relationship between the composed business process elements in the customized business process and the business entities.

4. The method of claim 1, wherein determining the relative location of the source business object node and the target business object node comprises determining a deployment unit in which the source business object node and the target business object node are deployed.

5. The method of claim 4, wherein determining the deployment unit in which the source business object node and the target business object node are deployed comprises determining whether the deployment unit is deployed in an infra-enterprise, inter-enterprise, or external enterprise application or system.

6. The method of claim 1, wherein selecting the communication interface for the source business object node and the target business object node comprises selecting an application-to-application (A2A) communication if both the source business object node and the target business object node are deployed in applications or systems within an enterprise.

7. The method of claim 1, wherein selecting the communication interface for the source business object node and the target business object node comprises selecting a business-to-business (B2B) communication if the source business object node and the target business object node are deployed in applications or systems across different enterprises.

8. The method of claim 1, wherein selecting the source business object node and the target business object node from the business process repository comprises selecting a partner-defined business object node as a source business object node and a pre-defined business object node as a target business object node and vice-versa from the business process repository.

9. The method of claim 1, wherein selecting the source business object node and the target business object node from the business process repository comprises selecting a partner-defined business objects as a source business object node and a target business object node from the business process repository.

10. The method of claim 1, wherein integrating the partner-defined business process elements to form the customized business process comprises embedding the partner-defined business process elements in a standard business process chain.

11. The method of claim 1, wherein integrating the partner-defined business process elements to form the customized business process comprises substituting the partner-defined business process elements for standard business process elements in a standard business process chain.

12. The method of claim 1, wherein integrating the partner-defined business process elements to form the customized business process comprises combining the partner-defined business process elements with one or more standard business process elements to form the customized business process.

13. An article of manufacture, comprising:
a computer readable storage medium having instructions which when executed by a computer causes the computer to:
create one or more business process elements composed of a partner-defined source business object node and a partner-defined target business object node, wherein the source business object node and the target business object node are connected via a partner-defined process communication;
integrate the composed one or more business process elements to form a customized business process; and
switch business entities to the customized business process.

14. The article of manufacture of claim 13, wherein the business entities are at least one of a user interface, form, report, tasks, and any other business process/element dependent entity.

15. The article of manufacture of claim 13, wherein the partner-defined process communication is determined based on a relative location of the source business object node and the target business object node.

16. The article of manufacture of claim 15, wherein the relative location of the source business object node and the target business object node is determined by determining a relative location of an application or system on which the source business object node and the target business object node are deployed.

17. The article of manufacture of claim 13, wherein the partner-defined process communication includes one of a direct communication, an application-to-application (A2A) communication, a business-to-business (B2B) communication, and application-to-external (A2X) communication.

18. The article of manufacture of claim 13, wherein integrating the composed business process elements to form a customized business process comprises embedding the composed business process elements in a standard business process chain.

19. A system comprising:
a data source system; and
a computer comprising a memory to store a program code, and a processor to execute the program code to:
compose one or more partner-defined business process elements by,
selecting a source business object node and a target business object node from the data source system, wherein the data source system holds partner-defined process entities;
determining a relative location of the source business object node and the target business object node; and
selecting a communication interface for the source business object node and the target business object node based on the relative location of the source business object node and the target business object node;
integrate the partner-defined business process elements to form a customized business process; and
switch business entities to the customized business process.

20. The system of claim 19, wherein the data source system includes at least one of a web service, a datamart, a data repository, an integrated ERP system, and external feed.
